(19) United States
(12) Patent Application Publication
(10) Pub. No.: US 2020/0233558 A1
(43) Pub. Date: Jul. 23, 2020

(54) Fingerprint and touch sensor and related signal processing method

(71) Applicant: NOVATEK Microelectronics Corp., Hsin-Chu (TW)

(72) Inventor: Tsen-Wei Chang, Taichung City (TW)

(21) Appl. No.: 16/558,337

(22) Filed: Sep. 3, 2019

Related U.S. Application Data
(60) Provisional application No. 62/795,517, filed on Jan. 22, 2019.

(51) Int. Cl. G06F 3/041; G06K 9/00

(52) U.S. Cl. CPC G06F 3/04166; G06K 9/00067; G06F 3/0418; G06K 9/0002

(57) ABSTRACT

A fingerprint and touch sensor includes a touch receiver, a fingerprint receiver, a mixer and a signal processing circuit. The touch receiver is configured to receive a touch sensing signal. The fingerprint receiver is configured to receive a fingerprint sensing signal having a first frequency. The mixer, coupled to the fingerprint receiver, is configured to move the fingerprint sensing signal in the first frequency to a second frequency. The signal processing circuit, coupled to the touch receiver and the mixer, is configured to process the fingerprint sensing signal in the second frequency and the touch sensing signal.

### CROSS REFERENCE TO RELATED APPLICATIONS

This application claims the benefit of U.S. Provisional Application No. 62/795,517, filed on Jan. 22, 2019, the contents of which are incorporated herein by reference.

### BACKGROUND OF THE INVENTION

### 1. Field of the Invention

The present invention relates to a fingerprint and touch sensor, and more particularly, to an integrated fingerprint and touch sensor and a related signal processing method.

### 2. Description of the Prior Art

Due to advancement of the touch sensing technology, many consumer electronic products such as mobile phones, GPS navigator systems, tablets, personal digital assistants (PDA) and laptops are equipped with touch sensing functions to realize excellent human-machine interactive performance. In various electronic products, touch sensing functions are included in a display area which originally had only display functions. In other words, an original display panel is replaced by a touch panel having both display and touch sensing functions. The touch panel can generally be classified into out-cell, in-cell and on-cell touch panel according to the difference in structure of the touch panel. The out-cell touch panel is composed of an independent touch panel and a general display panel. In the in-cell or on-cell touch panel, a touch sensing device is directly disposed on the inside or outside of a substrate in the display panel, respectively.

Nowadays, fingerprint sensing becomes a convenient way to satisfy identity recognition and other security requirements on these electronic products. The fingerprint sensing operation coexisting with the touch sensing operation and/or display operation generates non-ignorable interferences, which significantly increases the design difficulty and complexity of the touch panel.

### SUMMARY OF THE INVENTION

It is therefore an objective of the present invention to provide a fingerprint and touch sensor and a related signal processing method, where the fingerprint and touch sensing functions are integrated by using a frequency configuration capable of avoiding interferences, and the fingerprint and touch sensing signals are allowed to share the same signal processing circuit.

An embodiment of the present invention discloses a fingerprint and touch sensor, which comprises a touch receiver, a fingerprint receiver, a mixer and a signal processing circuit. The touch receiver is configured to receive a touch sensing signal. The fingerprint receiver is configured to receive a fingerprint sensing signal having a first frequency. The mixer, coupled to the fingerprint receiver, is configured to move the fingerprint sensing signal in the first frequency to a second frequency. The signal processing circuit, coupled to the touch receiver and the mixer, is configured to process the fingerprint sensing signal in the second frequency and the touch sensing signal.

Another embodiment of the present invention discloses a signal processing method for a fingerprint and touch sensor. The signal processing method comprising the steps of: receiving a touch sensing signal; receiving a fingerprint sensing signal having a first frequency; moving the fingerprint sensing signal in the first frequency to a second frequency; and processing the fingerprint sensing signal in the second frequency and the touch sensing signal with a same signal processing circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a touch sensing system in a TDDI system.

FIG. 2 is a schematic diagram of a touch sensing system in a non-TDDI system.

FIG. 3 is a schematic diagram of a fingerprint sensing system.

FIG. 4 is a schematic diagram of a general sensing system having both fingerprint and touch sensing functions.

FIG. 5 is a schematic diagram of weak frequencies in the fingerprint and touch sensing system.

FIG. 6 is a schematic diagram of a sensing system according to an embodiment of the present invention.

FIG. 7 is a schematic diagram of an exemplary implementation of the mixer.

FIG. 8 is a schematic diagram of an exemplary circuit structure of the mixer.

FIG. 9 is a schematic diagram of performing the touch sensing operation and the fingerprint sensing operation with time division.

FIG. 10 is a schematic diagram of band-pass filters and related frequency configurations for the touch and fingerprint sensing signals.

FIG. 11 is a schematic diagram of a signal processing process according to an embodiment of the present invention.

### DETAILED DESCRIPTION

In a touch panel using touch with display driver integration (TDDI) system, the controls of touch sensing operation and display operation are integrated in the same chip; hence, the interferences between the touch sensing operation and display operation may be minimized by using an appropriate control scheme. Please refer to FIG. 1, which is a schematic diagram of a touch sensing system 10 in a TDDI system. As shown in FIG. 1, the touch sensing system 10 includes a touch panel 100, which receives touch driving signals from a transmitter 102, and the corresponding touch sensing signals are sent to a receiver circuit including an analog front-end (AFE) circuit 104, an analog to digital converter (ADC) 106, and a digital back-end (DBE) circuit 108. In general, in a TDDI system such as the touch sensing system 10, the touch sensing operation and display operation may be well configured and synchronized to be performed with time division. Therefore, the noises sensed by the receiver circuit may be smaller, and a simpler circuit is enough to process and eliminate these noises. In consideration of cost issue, the receiver circuit may be implemented with low power and low area in the TDDI system.

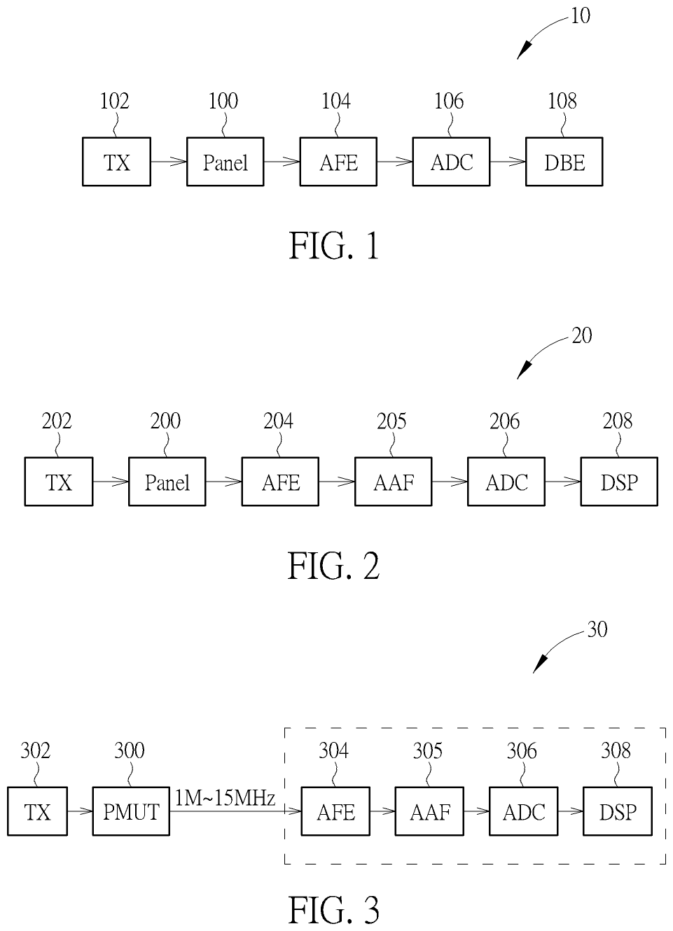

The touch sensing system 10 is usually applied in an in-cell touch panel. However, in an out-cell touch panel, the TDDI operation may not be feasible; that is, the touch sensing and display operations may be implemented in different chips, and these operations may not be well synchronized. Therefore, the touch sensing signal may be confronted with larger noises and interferences from the display operation, and thus a signal processing circuit having a higher noise cancellation capability is required. Please refer to FIG. 2, which is a schematic diagram of a touch sensing system 20 in a non-TDDI system. As shown in FIG. 2, the touch sensing system 20 includes a touch panel, which receives touch driving signals from a transmitter 202, and the corresponding touch sensing signals are sent to a receiver circuit including an AFE circuit 204, an anti-aliasing filter (AAF) 205, an ADC 206 and a digital signal processor (DSP) 208. In general, the touch driving signals and the corresponding touch sensing signals may be periodic signals having sine wave or rectangular wave, and the frequency of the periodic signal may be tens or hundreds of kilohertz (kHz).

Different from the receiver circuit in the touch sensing system 10, the receiver circuit in the touch sensing system 20 is more complex. The AAF 205, which is disposed between the AFE circuit 204 and the ADC 206, restricts the bandwidth of the received touch sensing signals to satisfy an adequate sampling theorem, so that the ADC 206 may sample the touch sensing signals to generate a sequence of data carrying entire information of the touch sensing signals. In this example, the ADC 206 is requested to perform high speed sampling to generate more effective data, as compared to the ADC 106. Further, the DSP 208 may include a band-pass filter and/or a demodulator, which may perform demodulation to generate the sensing result. In comparison with the DBE circuit 108, the DSP 208 in the touch sensing system 20 may have a more complex circuit structure, which occupies a larger area and consumes more power. In short, the touch sensing system 20 is capable of dealing with touch sensing signals under large noises and/or interferences, at the cost of high power consumption and large circuit area.

Please refer to FIG. 3, which is a schematic diagram of a fingerprint sensing system 30, which may be an ultrasonic fingerprint sensing system, for example. As shown in FIG. 3, the ultrasonic fingerprint sensing system 30 includes a piezoelectric micromachined ultrasonic transducer (PMUT) 300, which is served as a sensor for sensing fingerprint. The PMUT 300 may receive driving signals from a transmitter 302, and correspondingly send fingerprint sensing signals (which may be signals reflected from a touch finger) to a receiver circuit including an AFE circuit 304, an AAF 305, an ADC 306 and a DSP 308. In detail, the PMUT 300 is configured to convert electric driving signals into ultrasonic signals and deliver the ultrasonic signals. When there is a finger putting on the sensing area, the ultrasonic signals may be reflected from the finger and received by the receiver circuit. The fingerprint sensing signals received by the receiver circuit may have different phase shifts corresponding to peaks and valleys of the finger, so as to detect the feature of fingerprint. The DSP 308 is capable of demodulating the data sampled from the fingerprint sensing signals, so as to extract the information of the phase shifts.

In general, the operating frequency of the fingerprint sensing system 30 may be in megahertz (MHz) level. In other words, the fingerprint driving and sensing signals are periodic signals in several megahertz, e.g., 1 MHz-15 MHz, which is much higher than the operating frequency of the general touch sensing system 10 or 20. Although the receiver circuit of the fingerprint sensing system 30 has a structure similar to the receiver circuit of the fingerprint sensing system 20, they are operated indifferent frequencies to deal with different types of sensing signals. Both receiver circuits have to consume large power and occupy large circuit area.

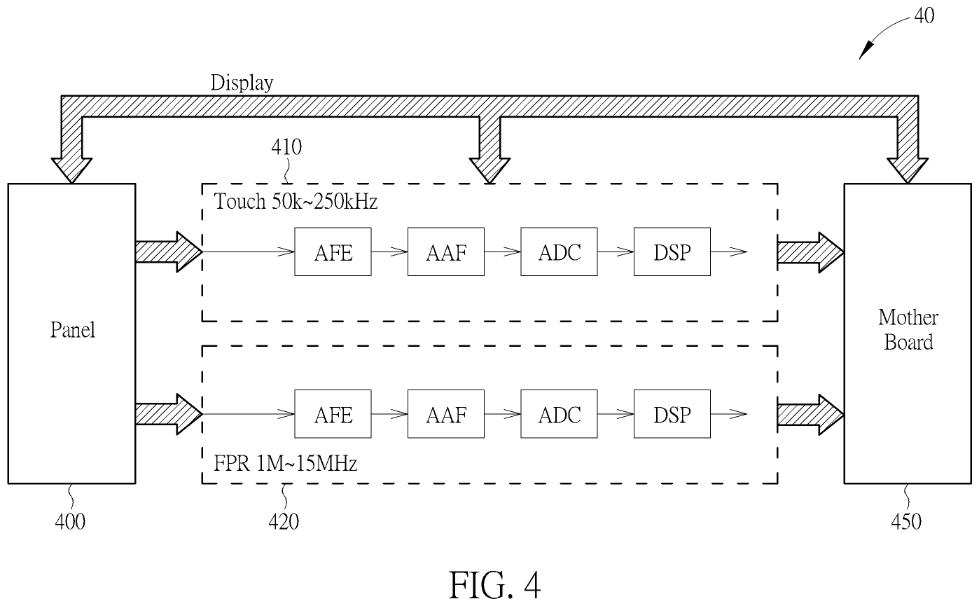

Please refer to FIG. 4, which is a schematic diagram of a general sensing system 40 having both fingerprint and touch sensing functions. As shown in FIG. 4, the sensing system 40 includes a panel 400, a touch sensing module 410, a fingerprint (FPR) sensing module 420 and a mother board 450. The sensing system 40 may be utilized in any type of electronic device having display, touch sensing and fingerprint sensing functions. The mother board 450 aims at handling the controls of the electronic device. For example, if the electronic device is a mobile phone, the mother board 450 may be a circuit board carrying the host, microcontroller unit (MCU), and/or main control circuit of the mobile phone. In this example, the touch sensing module 410 may be similar to the touch sensing system 20 shown in FIG. 2, and the fingerprint sensing module 420 may be similar to the fingerprint sensing system 30 shown in FIG. 3. The detailed implementations and operations of these modules are similar to those systems as described above, and will be omitted herein. Note that the touch sensing module 410 and the fingerprint sensing module 420 are usually implemented in two different chips. The touch sensing module 410 may be configured to process touch sensing signals ranging from 50 kHz to 250 kHz, and the fingerprint sensing module 420 may be configured to process fingerprint sensing signals ranging from 1 MHz to 15 MHz.

In general, in the sensing system 40, the panel 400 may be a touch panel, where the touch sensing pad is superposed on the display panel; hence, the touch sensing signals may be received from the touch panel 400. A wire may be connected between the touch panel 400 and the touch sensing module 410, allowing the touch sensing signals to be forwarded to the touch sensing module 410 from the touch panel 400. There is also a wire connected between the touch sensing module 410 and the mother board 450, and the touch sensing signals after being processed by the DSP may be forwarded to the mother board 450 through the wire.

With respect to fingerprint sensing, the piezoelectric materials such as the PMUT may be disposed on a pad near the panel 400 or superposed on the panel 400; hence, the fingerprint sensing signals may also be received from the touch panel 400. Similarly, a wire may be connected between the panel 400 and the fingerprint sensing module 420, allowing the fingerprint sensing signals to be forwarded to the fingerprint sensing module 420 from the panel 400. There is also a wire connected between the fingerprint sensing module 420 and the mother board 450, and the fingerprint sensing signals after being processed by the DSP may be forwarded to the mother board 450 through the wire.

In addition, the mother board 450 may communicate with the panel 400 for sending display data and related configurations, which may be sent and processed via a display driver. The display driver may be an independent module or chip included in the sensing system 40 or integrated with the touch sensing module 410, and is omitted in FIG. 4 for brevity. These connecting wires for touch sensing, fingerprint sensing and display operation may be connected from the same side of the panel 400 toward the mother board 450, and thus the dispositions of these connecting wires substantially overlap each other. This results in severe crosstalk interferences.

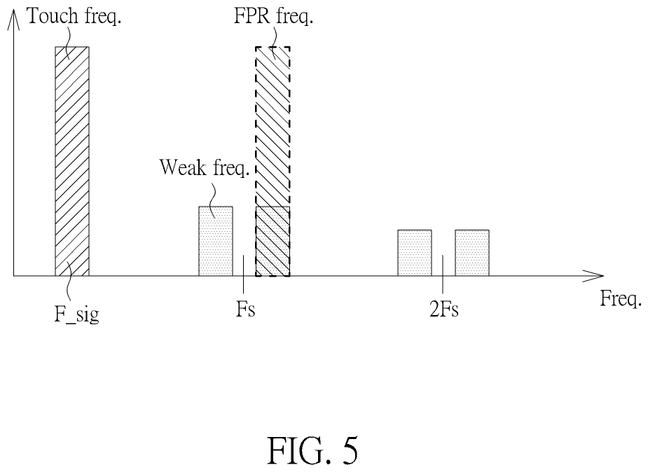

As mentioned above, both of the touch sensing signals and the fingerprint sensing signals are periodic signals having specific frequencies. The touch sensing signal may be configured to be in a frequency of kilohertz level such as between 50 kHz and 250 kHz, and the fingerprint sensing signal may be configured to be in a frequency of megahertz level such as between 1 MHz and 15 MHz. If these frequencies fail to be well configured, one of the touch and fingerprint sensing signals may easily be an interference of the other one. For example, due to the sampling theorem of digital signal processing, the weak frequencies may be calculated as N×F_s±F_sig, wherein F_s refers to the sampling frequency and F_sig refers to the signal frequency. A periodic noise signal on any of the weak frequencies may generate a severe aliasing effect, which distorts the received signal after sampling. As for the touch sensing module 410, the frequency of the touch sensing signal is F_sig, and the sampling frequency of the ADC is F_s, as shown in FIG. 5. Supposing that F_sig is equal to 100 kHz and F_s is equal to 1 MHz, the weak frequencies may include 0.9 MHz, 1.1 MHz, 1.9 MHz, 2.1 MHz, etc. Thus, if the fingerprint sensing signal is in or near any of the weak frequencies (e.g., 1.1 MHz as shown in FIG. 5), the fingerprint sensing signal may generate a severe aliasing effect on the touch sensing signal.

If the AAF disposed at the front of the ADC is an ideal filter, the aliasing effect may be entirely eliminated. However, the ideal AAF cannot be realized in a practical circuit system. If the AAF is not ideal, the periodic noise signal appearing on the weak frequencies may generate a non-ignorable aliasing effect. In order to solve this problem, a conventional method is to apply a more powerful AAF. However, the powerful AAF is usually accompanied by larger circuit area and higher power consumption, which result in increasing circuit costs. Therefore, a preferable solution is to change the operating frequency of the fingerprint sensing system and/or change the operating frequency of the touch sensing system, to prevent the operating frequency of the fingerprint sensing system from being on the weak frequencies of the processing device of the touch sensing signal.

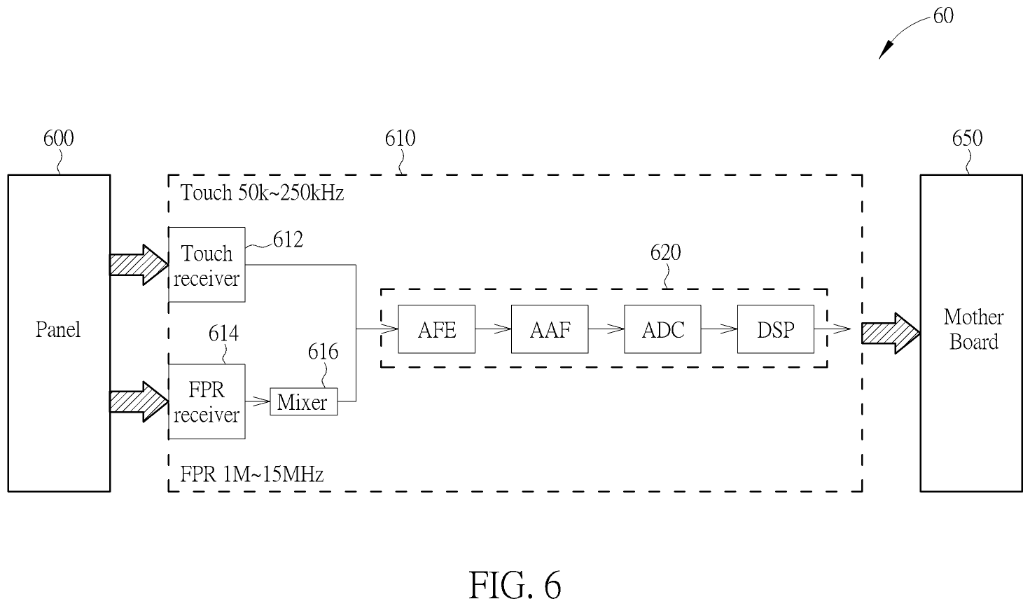

Please refer to FIG. 6, which is a schematic diagram of a sensing system 60 according to an embodiment of the present invention. As shown in FIG. 6, the sensing system 60, which is capable of the fingerprint and touch sensing functions, includes a panel 600, a fingerprint and touch sensor 610 and a mother board 650. The panel 600 and the mother board 650 are identical to the panel 400 and the mother board 450 in the sensing system 40, and their implementations and operations are described in the above paragraphs and will not be narrated herein. The fingerprint and touch sensor 610 includes a touch receiver 612, a fingerprint receiver 614, a mixer 616 and a signal processing circuit 620. In detail, the touch receiver 612 is configured to receive a touch sensing signal, and the fingerprint receiver 614 is configured to receive a fingerprint sensing signal. In an embodiment, the fingerprint sensing signal is an ultrasonic fingerprint sensing signal received from an ultrasonic fingerprint sensor such as the PMUT. The mixer 616, coupled to the fingerprint receiver 614, is configured to adjust or change the frequency of the fingerprint sensing signal. For example, if the fingerprint sensing signal received by the fingerprint receiver 614 is in a first frequency, the mixer 616 may move the fingerprint sensing signal in the first frequency to a second frequency. Therefore, the signal processing circuit 620, which is coupled to the touch receiver 612 and the mixer 616, may process the touch sensing signal and the fingerprint sensing signal in the second frequency. In an embodiment, the touch sensing function and fingerprint sensing function may be integrated in the same integrated circuit and chip with the implementation of the fingerprint and touch sensor 610, to achieve the benefit of lower circuit costs as compared to the sensing system 40.

As mentioned above, the frequency of the touch sensing signal is generally tens or hundreds of kilohertz, while the frequency of the fingerprint sensing signal is generally in megahertz level. In order to share the same signal processing circuit 620 with the touch sensing signal, the frequency of the fingerprint sensing signal may be converted downward to be near the frequency of the touch sensing signal. That is, the fingerprint sensing signal in the first frequency may be moved or converted, by the mixer 616, to the second frequency lower than the first frequency. Preferably, the second frequency of the fingerprint sensing signal and the frequency of the received touch sensing signal may be in the same order of magnitude, in order to facilitate the circuit design of various modules in the signal processing circuit 620. For example, if the frequency of the touch sensing signal is in a level of hundreds of kilohertz, the frequency of the fingerprint sensing signal may be converted to be in the level of hundreds of kilohertz.

In an embodiment, each of the modules in the signal processing circuit 620 may have an operable frequency range, and the frequency of the touch sensing signal is within the operable frequency ranges of these modules. Therefore, the frequency of the fingerprint sensing signal should be converted downward to be within the operable frequency range of each of the modules in the signal processing circuit 620. In such a situation, the signal processing circuit 620, which is originally applicable to deal with the touch sensing signal, may also be used to deal with the fingerprint sensing signal. As shown in FIG. 6, the signal processing circuit 620 may include, for example, an AFE circuit, an AAF, an ADC and/or a DSP. These modules are able to process the touch sensing signal and the fingerprint sensing signal after frequency down-conversion.

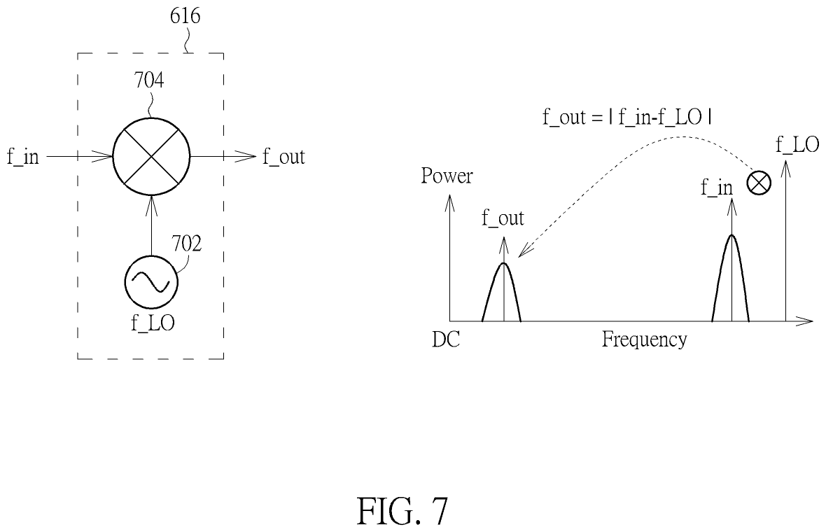

In the above embodiments, the down-conversion of the frequency of the fingerprint sensing signal is performed by the mixer 616, which may be realized in any manner. Please refer to FIG. 7, which is a schematic diagram of an exemplary implementation of the mixer 616. As shown in FIG. 7, the mixer 616 includes a local oscillator 702 and a multiplier 704. The local oscillator 702 may generate a local signal having frequency f_LO. The multiplier 704 may multiply an input signal having frequency f_in with the local signal having frequency f_LO, to generate an output signal having frequency f_out. The signal frequencies of the mixer 616 may satisfy the following equation: f_out=|f_in−f_LO|. Therefore, with a well configured frequency of the local oscillator 702, the mixer 616 may convert the fingerprint sensing signal to an appropriate lower frequency conforming to the operable frequency range of the signal processing circuit 620. For example, if the fingerprint sensing signal received by the fingerprint receiver 614 is in 1 MHz while the touch sensing signal received by the touch receiver 612 is in 300 kHz, the local oscillator 702 may be configured to generate a local signal in 1.25 MHz. Therefore, the mixer 616 may convert the frequency of the fingerprint sensing signal from 1 MHz to 250 kHz, which is much closer to the frequency of the touch sensing signal and may be processed by the signal processing circuit 620.

FIG. 8 illustrates an exemplary circuit structure of the mixer 616. The circuit, which may be served as a multiplier, includes two sets of differential input transistors respectively receiving the input signal in frequency f_in and the local signal in frequency f_LO (which is generated internally), so as to generate the output signal as the multiplication result of the input signal and the local signal.

According to the embodiments of the present invention, the touch sensing function and the fingerprint sensing function may share the same signal processing circuit 620 in the fingerprint and touch sensor 610, and thus the related circuit may be integrated in the same chip. The wire connection may thereby be simplified, which reduces the crosstalk problem. Further, since the touch sensing signal and the fingerprint sensing signal are processed in the same integrated circuit, the related driving signals may be configured to be well synchronized and/or configured with appropriate frequencies to avoid interferences.

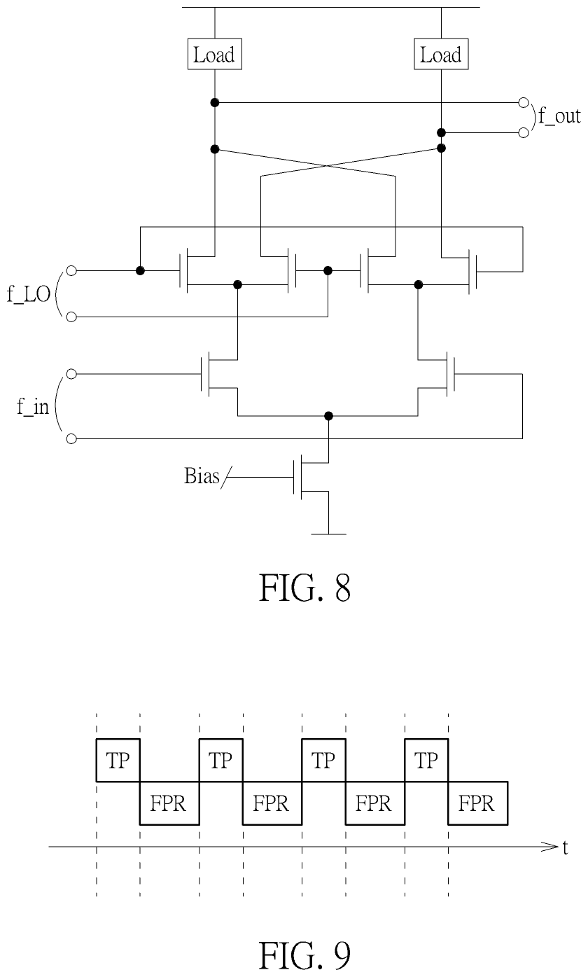

Please refer to FIG. 9, which is a schematic diagram of performing the touch sensing operation and the fingerprint sensing operation with time division. As shown in FIG. 9, the operation time may be divided into several time slots, and each time slot is allocated with one of the touch sensing operation (TP) and the fingerprint sensing operation (FPR). Therefore, the touch sensing operation and the fingerprint sensing operation may not be interfered with by each other. For example, the driving signals for touch and fingerprint sensing may be sent in different time slots, so that the signal processing circuit 620 may be dedicated to process one of the touch sensing signal and the fingerprint sensing signal in each time slot.

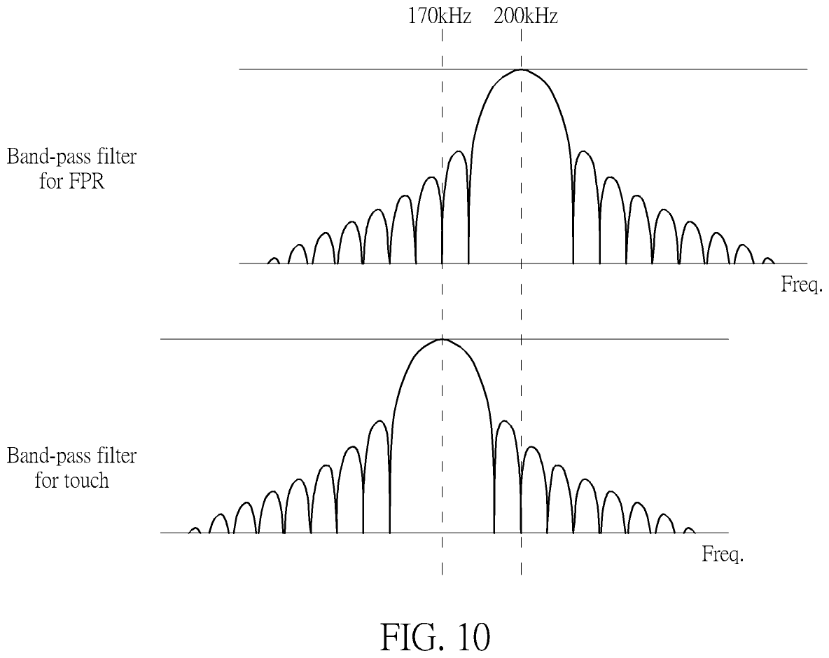

In another embodiment, the touch and fingerprint sensing operations may coexist at the same time without interferences by well controlling the frequencies of the touch sensing signal and the fingerprint sensing signal; this may be realized by controlling the frequencies of the corresponding driving signals based on the band-pass filters in the DSP. Please refer to FIG. 10, which is a schematic diagram of band-pass filters and related frequency configurations for the touch and fingerprint sensing signals. In order to effectively obtain the desired signals, the DSP in the signal processing circuit 620 may include a band-pass filter for passing the touch sensing signal and a band-pass filter for passing the fingerprint sensing signal. These band-pass filters may have frequency responses as shown in FIG. 10. In detail, each band-pass filter has several notch frequencies, on which signals may be entirely filtered out. Therefore, the frequency of the fingerprint sensing signal may be configured to be substantially equal to a notch frequency of the band-pass filter for the touch sensing signal, and/or the frequency of the touch sensing signal may be configured to be substantially equal to a notch frequency of the band-pass filter for the fingerprint sensing signal. For example, the touch sensing signal may be in 170 kHz, and the fingerprint sensing signal may be converted downward to 200 kHz by the mixer. These frequencies are notch frequencies of the filter for each other. In other words, these frequencies are orthogonal to each other.

Please note that the present invention aims at providing a fingerprint and touch sensor and a related signal processing method where the fingerprint and touch sensing functions are integrated and the fingerprint and touch sensing signals are allowed to share the same signal processing circuit. Those skilled in the art may make modifications and alternations accordingly. For example, in the fingerprint and touch sensor 610 shown in FIG. 6, the signal processing circuit 620 includes an AFE circuit, an AAF, an ADC and a DSP. Those skilled in the art should understand that the implementation of devices and modules in the signal processing circuit may be performed in any manners according to system requirements. For example, if the fingerprint sensing operation is well synchronized with the touch sensing operation and display operation so that these operations are performed in different time slots without periodic noises, the corresponding signal processing circuit 620 may be simplified in order to achieve cost reduction. For example, the AAF may be omitted, and/or the DSP may be implemented with a simpler structure. In addition, the circuit structure of the mixer mentioned above is one of various implementations of the present invention. Any other types of mixer are also feasible to perform frequency conversion on the fingerprint sensing signal. Further, the frequency values provided in this disclosure are merely served to describe the exemplary embodiments, and should not be used to limit the scope of the present invention.

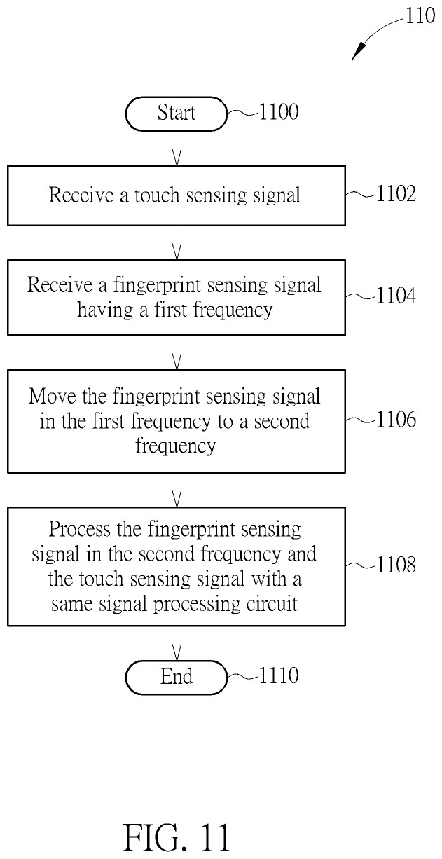

The abovementioned signal processing method for the fingerprint and touch sensing signals may be summarized into a signal processing process 110, as shown in FIG. 11. The signal processing process 110, which may be implemented in a fingerprint and touch sensor such as the fingerprint and touch sensor 610 shown in FIG. 6, includes the following steps:

Step 1100: Start.

Step 1102: Receive a touch sensing signal.

Step 1104: Receive a fingerprint sensing signal having a first frequency.

Step 1106: Move the fingerprint sensing signal in the first frequency to a second frequency.

Step 1108: Process the fingerprint sensing signal in the second frequency and the touch sensing signal with a same signal processing circuit.

Step 1110: End.

The detailed operations and alternations of the signal processing process 110 are illustrated in the above paragraphs, and will not be narrated herein.

To sum up, the embodiments of the present invention provide a fingerprint and touch sensor and a related signal processing method. The fingerprint and touch sensing functions may be integrated in the same chip, and the interferences between the fingerprint and touch sensing operations may be reduced by using an appropriate frequency configuration such as orthogonal frequencies, or by processing the touch sensing signal and the fingerprint sensing signal in different time slots. Therefore, the fingerprint and touch sensing operations may share the same signal processing circuit. Also, the wire connection for fingerprint and touch sensing operations may be simplified, which reduces the crosstalk interferences.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A fingerprint and touch sensor, comprising:
a touch receiver, configured to receive a touch sensing signal;
a fingerprint receiver, configured to receive a fingerprint sensing signal having a first frequency;
a mixer, coupled to the fingerprint receiver, configured to move the fingerprint sensing signal in the first frequency to a second frequency; and
a signal processing circuit, coupled to the touch receiver and the mixer, configured to process the fingerprint sensing signal in the second frequency and the touch sensing signal.

2. The fingerprint and touch sensor of claim 1, wherein the received touch sensing signal has a third frequency, and the second frequency and the third frequency are in the same order of magnitude.

3. The fingerprint and touch sensor of claim 1, wherein the received touch sensing signal has a third frequency, and the second frequency and the third frequency are within an operable frequency range of the signal processing circuit.

4. The fingerprint and touch sensor of claim 1, wherein the second frequency is lower than the first frequency.

5. The fingerprint and touch sensor of claim 1, wherein the signal processing circuit processes the touch sensing signal and the fingerprint sensing signal with time division.

6. The fingerprint and touch sensor of claim 1, wherein the received touch sensing signal has a third frequency, and the second frequency and the third frequency are orthogonal to each other.

7. The fingerprint and touch sensor of claim 1, wherein the signal processing circuit comprises:
a first filter, configured to pass the touch sensing signal; and
a second filter, configured to pass the fingerprint sensing signal;
wherein the second frequency of the fingerprint sensing signal is a notch frequency of the first filter, and a third frequency of the touch sensing signal is a notch frequency of the second filter.

8. The fingerprint and touch sensor of claim 1, wherein the signal processing circuit comprises at least one of an analog front-end circuit, an anti-aliasing filter, an analog to digital converter, and a digital signal processor.

9. The fingerprint and touch sensor of claim 1, wherein the fingerprint sensing signal is received from an ultrasonic fingerprint sensor.

10. A signal processing method for a fingerprint and touch sensor, comprising:
receiving a touch sensing signal;
receiving a fingerprint sensing signal having a first frequency;
moving the fingerprint sensing signal in the first frequency to a second frequency; and
processing the fingerprint sensing signal in the second frequency and the touch sensing signal with a same signal processing circuit.
